(19) United States
(12) Patent Application Publication
(10) Pub. No.: US 2023/0305515 A1
(43) Pub. Date: Sep. 28, 2023

(54) MACHINE TOOL CONTROLLER

(71) Applicant: FANUC CORPORATION, Yamanashi (JP)

(72) Inventor: Miho NIIKURA, Yamanashi (JP)

(73) Assignee: FANUC CORPORATION, Yamanashi (JP)

(21) Appl. No.: 18/043,110

(22) PCT Filed: Sep. 21, 2021
(86) PCT No.: PCT/JP2021/034514

§ 371 Date: Feb. 27, 2023

(30) Foreign Application Priority Data
Sep. 25, 2020 (JP) 2020-160887

(51) Int. Cl. G05B 19/406; G05B 19/409

(52) U.S. Cl. CPC G05B 19/406; G05B 19/409

(57) ABSTRACT

A machine tool controller including a storage unit configured to store three-dimensional basic shape data, a region setting unit that creates a collision detection region of an auxiliary mechanism and sets the collision detection region, and an input unit to which an operator inputs a setting value for a plurality of setting items for determining positions of a plurality of boundary surfaces of the collision detection region, where the plurality of setting items includes at least one non-essential item for which input of the setting value is not mandatory, the region setting unit sets the collision detection region based on the setting value input through the input unit, and, when there is an un-input item as the non-essential item, the region setting unit sets at least one of the boundary surfaces to be determined by the un-input item at an edge of the predetermined setting region.

### TECHNICAL FIELD

The present invention relates to a machine tool controller.

### BACKGROUND

Auxiliary mechanisms such as a fixture for fixing a workpiece to a table and an additional axis table for changing the orientation of the workpiece relative to the table are installed on the table of a machine tool. In order to prevent unintended collision between the auxiliary mechanisms and the tool during operation of the machine tool, there is a known machine tool controller that has a function for detecting collision between the tool and the auxiliary mechanisms (for example, see Japanese Unexamined Patent Application, Publication No. H08-115117 and Japanese Unexamined Patent Application, Publication No. 2006-102923). According to Japanese Unexamined Patent Application, Publication No. H08-115117 and Japanese Unexamined Patent Application, Publication No. 2006-102923, collision regions of the auxiliary mechanisms and the tool are set by using three-dimensional data of the auxiliary mechanisms and the tool, movements of the auxiliary mechanisms and the tool are simulated, and it is checked whether or not the collision regions interfere with each other.

### SUMMARY

An aspect of the present disclosure provides a machine tool controller that has a function for detecting collision between a tool and an auxiliary mechanism on a table, the controller including: a storage unit configured to store three-dimensional basic shape data; a region setting unit that creates a collision detection region of the auxiliary mechanism based on the basic shape data and sets the collision detection region within a predetermined setting region encompassing the auxiliary mechanism; and an input unit to which an operator inputs a setting value for a plurality of setting items for determining positions of a plurality of boundary surfaces of the collision detection region, wherein the plurality of setting items include at least one non-essential item for which input of the setting value is not mandatory, the region setting unit sets the collision detection region based on the setting value input through the input unit, and when there is an un-input item, which is the non-essential item for which no setting value is input, the region setting unit sets at least one of the boundary surfaces to be determined by the un-input item at an edge of the predetermined setting region.

### BRIEF DESCRIPTION OF THE DRAWINGS

FIG. 1 is a schematic diagram illustrating the overall structure of a machine tool.

FIG. 2 is a plan view illustrating one example of a collision detection region of an additional two-axes table.

FIG. 3 is a side view illustrating one example of a collision detection region of an additional two-axes table.

FIG. 4 is a plan view illustrating one example of an extended collision detection region of an additional two-axes table.

FIG. 5 is a side view illustrating one example of an extended collision detection region of an additional two-axes table.

FIG. 6 is a flowchart illustrating a collision detection region setting method performed by a controller of the machine tool illustrated in FIG. 1.

FIG. 7 is a plan view illustrating one example of a collision detection region of a vise.

FIG. 8 is a side view illustrating one example of a collision detection region of a vise.

FIG. 9 is a plan view illustrating one example of an extended collision detection region of a vise.

FIG. 10 is a side view illustrating one example of an extended collision detection region of a vise.

### DETAILED DESCRIPTION OF EMBODIMENTS

Shapes and dimensions of auxiliary mechanisms being used may differ from each user. Furthermore, even with the same auxiliary mechanism, the installation directions and the installation positions may differ from each user. Thus, setting the collision region takes time and is inconvenient.

A machine tool 10 and a controller 1 therefor according to an embodiment will be described with reference to the drawings.

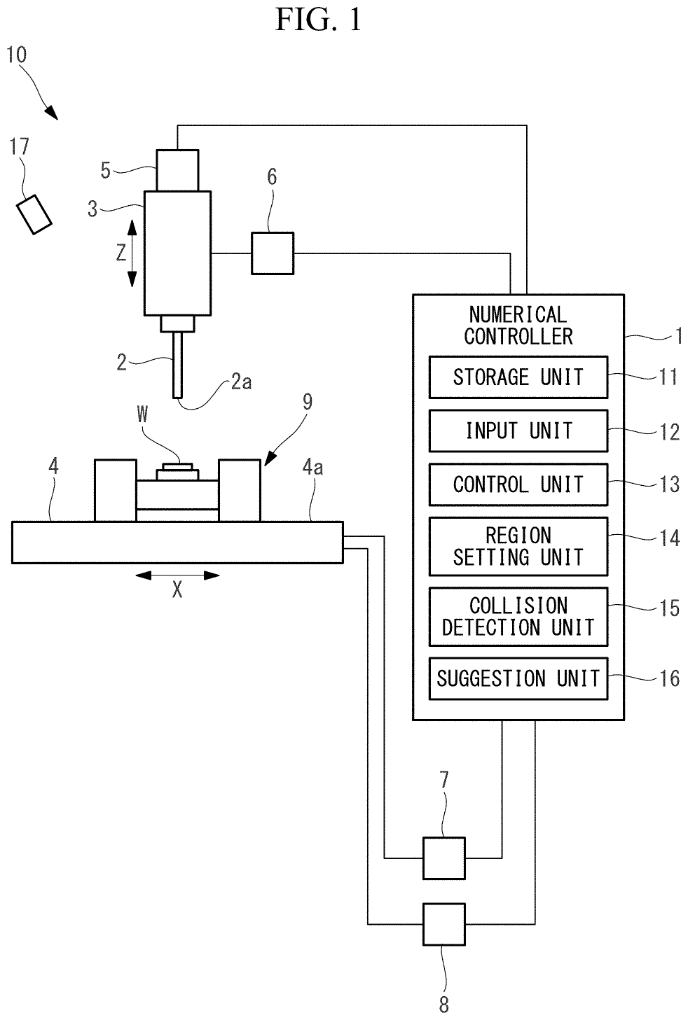

As illustrated in FIG. 1, the machine tool 10 is equipped with a spindle 3 that holds a tool 2, a table 4 on which a workpiece W is placed, a spindle motor 5 that rotates the spindle 3, a Z-axis feed motor 6 that moves the spindle 3 in the Z direction relative to the table 4, an X-axis feed motor 7 and a Y-axis feed motor 8 that respectively move the table 4 in the X direction and the Y direction relative to the spindle 3, and a numerical controller 1 that controls the motors 5, 6, 7, and 8.

The Z direction is a direction along the longitudinal axis of the tool 2 held by the spindle 3. The X and Y directions are directions orthogonal to the longitudinal axis of the tool 2 held by the spindle 3, and are orthogonal to each other. In the machine tool 10 illustrated in FIG. 1, the Z direction is a vertical direction, and the X and Y directions are horizontal directions.

The spindle 3 is arranged in the vertical direction and is supported by a supporting mechanism (not illustrated in the drawings) so as to be movable in the vertical direction. The tool 2 is held at the lower end portion of the spindle 3 so as to be coaxial with the spindle 3 and rotates and moves together with the spindle 3.

The table 4 is horizontally arranged under the spindle 3. An auxiliary mechanism 9 that holds the workpiece W is installed on a mounting surface 4a, which is an upper surface, of the table 4. Examples of the auxiliary mechanism 9 include a fixture that fixes the workpiece W to the table 4 and an additional axis table that changes the orientation of the workpiece W relative to the table 4.

The feed motors 6, 7, and 8 are servo motors. The feed motors 7 and 8 move the table 4 in the X direction and the Y direction and thereby move the tool 2 in the X direction and the Y direction relative to the table 4 within a predetermined motion range. For example, the motion range in the X direction is between two ends of the table 4 in the X direction, and the motion range in the Y direction is between two ends of the table 4 in the Y direction.

The controller 1 is equipped with a storage unit 11, an input unit 12, and a control unit 13.

The storage unit 11 has a RAM, a ROM, or any other desired storage devices.

The input unit 12 has a touch panel, a mouse, a keyboard, or the like. The operator can perform various input operations to the controller 1 through the input unit 12.

During automatic operation, the control unit 13 sends control commands based on a machining program stored in the storage unit 11 to the motors 5, 6, 7, and 8 and thereby controls the movements of the spindle 3 and the table 4. During manual operation, the control unit 13 sends, to the motors 5, 6, 7, and 8, control commands based on inputs made by the operator through an operation input device (not illustrated) and thereby controls the movements of the spindle 3 and the table 4. The control unit 13 is realized by at least one processor, such as a central processing unit, built in the controller 1.

Furthermore, the controller 1 is equipped with a region setting unit 14 and a collision detection unit 15 as the functions that detect collision between the tool 2 and the auxiliary mechanisms 9 during automatic or manual operation of the machine tool 10. The region setting unit 14 and the collision detection unit 15 are realized by processors as the control unit 13 is.

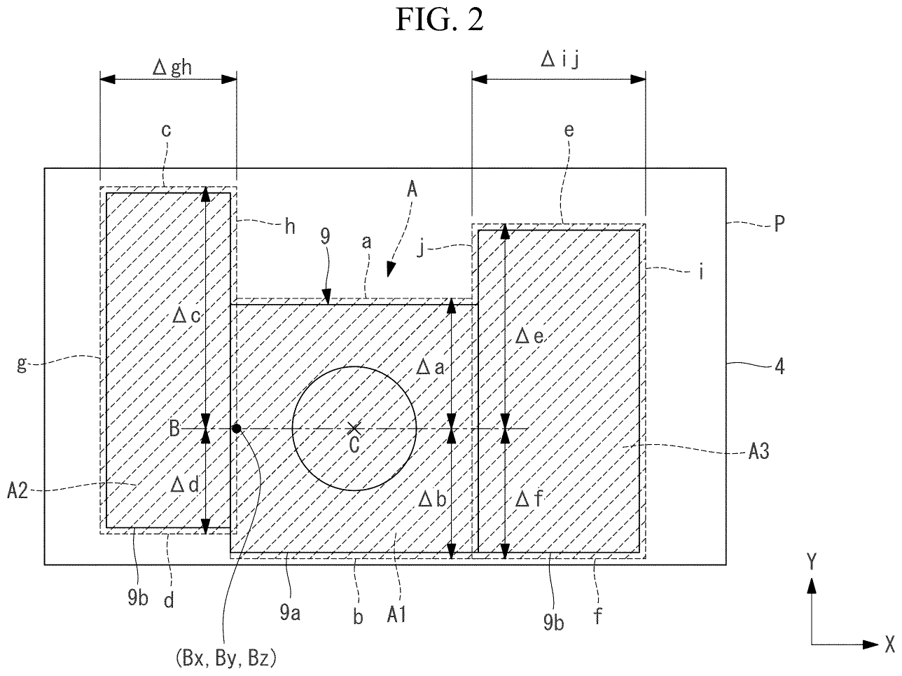

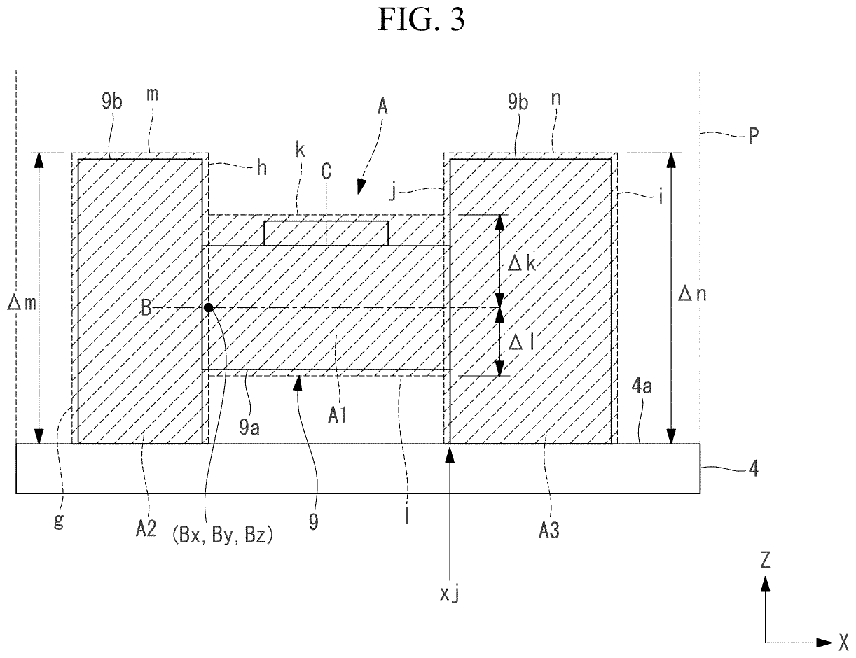

In order to detect collision, as illustrated in FIGS. 2 and 3, a collision detection region A of the auxiliary mechanisms 9 is set within a predetermined setting region P. The setting region P is a three-dimensional region that encompasses the auxiliary mechanism 9 and that is pre-set in the controller 1, and is, for example, a motion range of the tool 2. The collision detection region A is constituted by a single region or a combination of multiple partial regions A1, A2, and A3. The single region and the partial regions A1, A2, and A3 each have a simple shape such as a rectangular parallelepiped shape or a cylinder shape.

FIGS. 2 and 3 illustrate an example of the collision detection region A when the auxiliary mechanism 9 is an additional two-axes table arranged parallel to the X direction. The additional two-axes table 9 has a rotary table 9a and two motor units 9b, and the rotary table 9a can rotate about a tilting axis B parallel to the X direction and about a rotary axis C, which is the center axis of the rotary table 9a.

The storage unit 11 stores multiple sets of three-dimensional basic shape data for creating the collision detection region A. The multiple sets of basic shape data involve shapes different from one another, and each set of basic shape data is constituted by a combination of simple shapes such as a rectangular parallelepiped shape and a cylinder shape.

The operator can select the basic shape data to use for the collision detection region A through the input unit 12. In the case of the collision detection region A illustrated in FIGS. 2 and 3, the basic shape data constituted by three rectangular parallelepiped shapes corresponding to the three partial regions A1, A2, and A3 is selected.

For example, each set of basic shape data is associated with at least one type of auxiliary mechanism 9. Specifically, the basic shape data constituted by three rectangular parallelepiped shapes is associated with an additional two-axes table. The operator selects the auxiliary mechanism 9 to use from a list of types of the auxiliary mechanisms 9 displayed on the setting screen of the controller 1. Once an auxiliary mechanism 9 is selected, at least one set of basic shape data associated with the selected auxiliary mechanism 9 is displayed on the setting screen. The operator selects, through the input unit 12, one set of data from among the basic shape data displayed on the screen.

In order to define the collision detection region A, it is necessary to determine the positions of boundary surfaces that define the collision detection region A. The operator can input, to the input unit 12, setting values of multiple setting items for determining the positions of the boundary surfaces. In the example illustrated in FIGS. 2 and 3, the collision detection region A is defined by nineteen boundary surfaces a, b, . . . , m, and n, and in order to determine the positions of the boundary surfaces a, b, . . . , m, and n, sixteen setting items 1 to 16 are provided.

The setting items 1 to 3 are the XYZ coordinates (Bx, By, Bz) of the position of the tilting axis B at one side surface of the rotary table 9a.

The setting item 4 is the X coordinate xj of the other side surface of the rotary table 9a.

The setting items 5, 6, 7, 8, 9, 10, 11, and 12 are, respectively, the distances Δa, Δb, Δc, Δd, Δe, Δf, Δk, and Δl from the tilting axis (predetermined axis) B to boundary surfaces a, b, c, d, e, f, k, and l parallel to the tilting axis B, respectively.

The setting item 13 is the width Δgh between the boundary surfaces h and g, and the setting item 14 is the width Δij between the boundary surfaces i and j.

The setting items 15 and 16 are, respectively, the distances Δm and Δn from the mounting surface 4a to the boundary surfaces m and n, respectively.

For example, the input unit 12 is an operator's panel that has a numeric key pad, and the operator uses the numeric key pad to input the setting values to the input unit 12. When the input unit 12 has a touch panel, the operator may input the setting values by touch by moving the positions of the boundary surfaces of the basic shape data displayed on the touch panel to the positions corresponding to the shape and dimensions of the auxiliary mechanism 9 to be used. When the input unit 12 has a voice-input device such as a microphone, the setting values may be input via the voice of the operator.

The multiple setting items include essential items that require the operator to input setting values, and at least one non-essential item that does not require the operator to input a setting value.

Examples of the non-essential item are items Δc, Δd, Δe, Δf, Δgh, and Δij for determining the positions of the boundary surfaces c, d, e, f, g, and i of the partial regions A2 and A3 that encompass the stationary portions 9b of the auxiliary mechanism 9 among the boundary surfaces facing the outside of the collision detection region A in the X direction and the Y direction along the mounting surface 4a. The stationary portion 9b is a portion that remains stationary relative to the table 4, and, in the case of the additional two-axes table, the stationary portion 9b is a portion that does not synchronize with the rotation about the rotary axis C of the auxiliary mechanism 9.

Another example of the non-essential items is the item Δl for determining the position of the table-4-side boundary surface 1 in the partial region A1 encompassing the movable portion 9a of the auxiliary mechanism 9. The movable portion 9a is a portion that can move relative to the table 4, and, in the case of the additional two-axes table, is a portion that synchronizes with the rotation about the rotary axis C of the auxiliary mechanism 9.

The region setting unit 14 acquires, from the storage unit 11, the basic shape data of the shape selected through the input unit 12. Next, the region setting unit 14 creates a collision detection region A on the basis of the basic shape data selected through the input unit 12 and the setting values of the setting items, and sets the collision detection region A within the setting region P. In other words, the region setting unit 14 creates a collision detection region A by extending or shrinking the basic shape data in the X, Y, and Z directions and thereby placing the boundary surfaces of the basic shape data to the positions determined by the setting values.

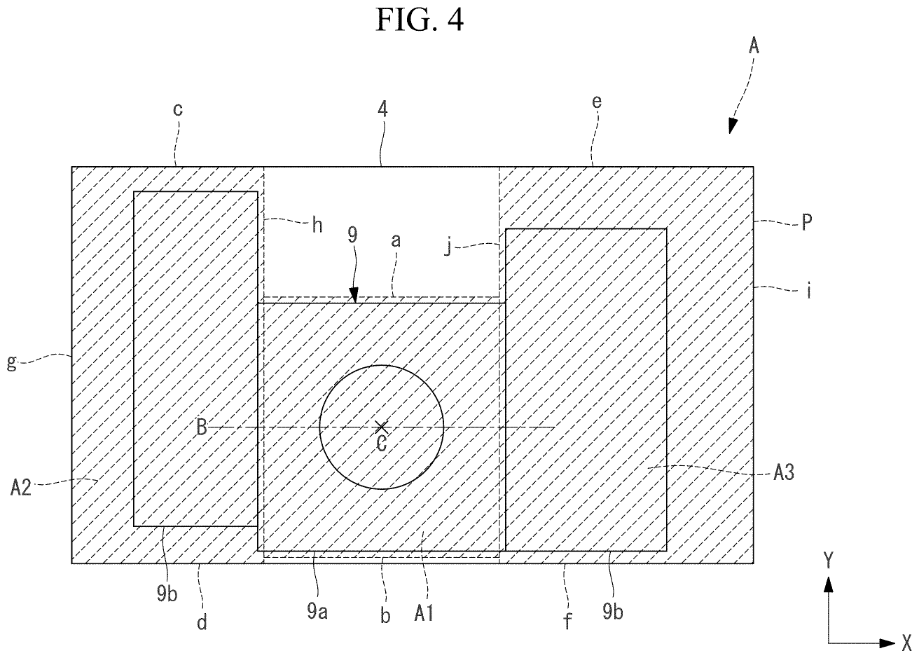

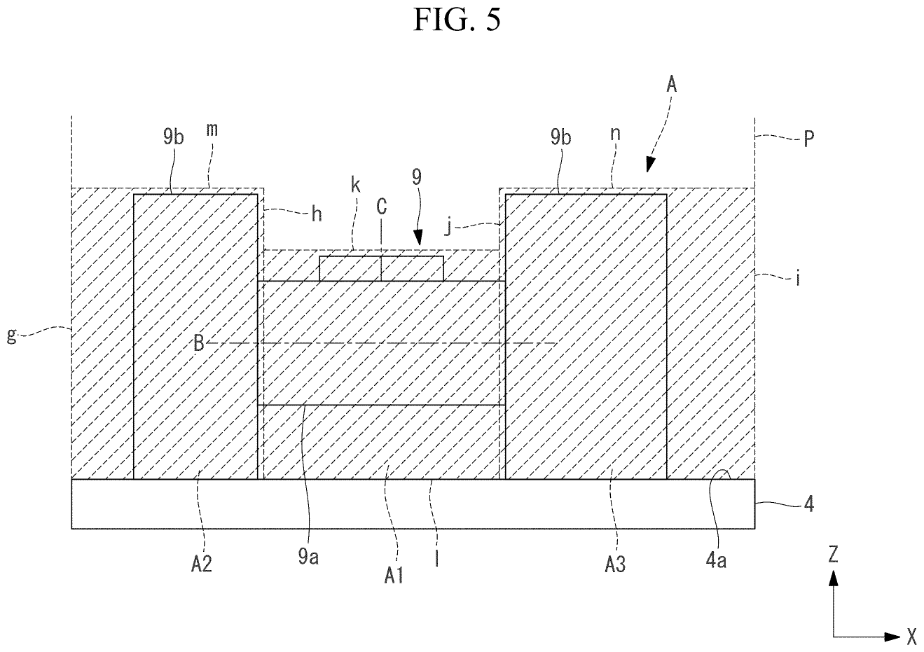

As described above, the region setting unit 14 determines the positions of the boundary surfaces on the basis of the setting values of the essential items and non-essential items input through the input unit 12. When there is an un-input item, which is a non-essential item for which no setting value is input, the region setting unit 14 determines that the boundary surface determined by the un-input item is an edge of the setting region P that is on the same side as that boundary surface with respect to the collision detection region A and that faces the boundary surface. FIGS. 2 and 3 illustrate a collision detection region A when setting values are input for all of the setting items. FIGS. 4 and 5 illustrate an extended collision detection region A when setting values are not input for some of the non-essential items.

Specifically, when the items Δgh and Δij are un-input items, the boundary surfaces g and i are determined to be edges of the setting region P, and, as a result, the partial regions A2 and A3 encompassing the motor units 9b are extended in the X direction to the edges of the setting region P.

When the items Δc, Δd, Δe, and Δf are un-input items, the boundary surfaces c, d, e, and f are determined to be edges of the setting region P, and, as a result, the partial regions A2 and A3 encompassing the motor units 9b are extended in the Y direction to the edges of the setting region P.

When the item Δl is an un-input item, the boundary surface 1 is determined to be the mounting surface 4a, which is an underside edge of the setting region P, and, as a result, the region A1 encompassing the rotary table 9a is extended in the Z direction.

The collision detection unit 15 checks whether or not the tool 2 and the collision detection region A collide with each other. For example, before the control unit 13 sends control commands to the feed motors 6, 7, and 8, the collision detection unit 15 calculates the positions of the tool 2 and the collision detection region A on the basis of the presumption that the tool 2 and the table 4 have moved according to the control commands, and checks whether or not the tool 2 and the collision detection region A at the calculated positions collide with each other.

When the collision detection unit 15 determines that the tool 2 and the collision detection region A collide with each other, the control unit 13 controls the feed motors 6, 7, and 8 to allow at least one of the spindle 3 and the table 4 to perform a motion that avoids collision. For example, the control unit 13 stops the spindle 3 and the table 4, or moves the spindle 3 and the table 4 away from each other.

Next, the effects of the controller 1 of the machine tool 10 are described.

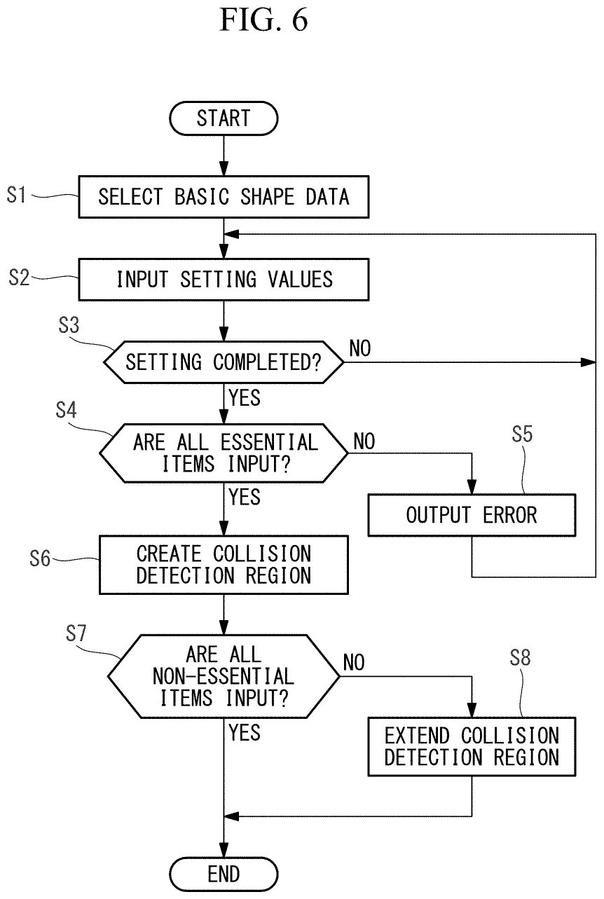

After installing the auxiliary mechanism 9 on the mounting surface 4a of the table 4 and before starting automatic or manual operation, the collision detection region A is set as illustrated in FIG. 6.

First, the operator selects, through the input unit 12, the basic shape data used for the collision detection region A (step S1). Next, the operator inputs, through the input unit 12, the setting values for determining multiple boundary surfaces of the collision detection region A (step S2).

After the input of the setting values is completed (YES in step S3), the region setting unit 14 confirms that all of the setting values of the essential items have been input (step S4). Completion of input of the setting values is determined by the operator pressing a predetermined button on the setting screen. If there is any essential item for which the setting value is not input, the controller 1 outputs an error (step S5) and requires the operator to input the setting value for the un-input essential item.

Next, on the basis of the basic shape data selected in the step S1 and the setting values input in the step S2, the region setting unit 14 creates and sets the collision detection region A of the auxiliary mechanism 9 (step S6).

When setting values are input for all non-essential items, as illustrated in FIGS. 2 and 3, the positions of all boundary surfaces a, b, . . . , m, and n of the collision detection region A are determined on the basis of the setting values. However, when a setting value is not input for at least one non-essential item, the position of the boundary surface corresponding to the un-input item remains undetermined, and the process proceeds to step S7.

Next, the region setting unit 14 confirms whether or not the setting values have been input for all non-essential items (step S7). When setting values have been input for all non-essential items (YES in step S7), creation and setting of the collision detection region A of the auxiliary mechanism 9 end.

However, when there is at least one un-input item (NO in step S7), the region setting unit 14 determines that the undetermined boundary surface is an edge of the predetermined setting region P, and this extends the collision detection region A to the edge of the setting region P (step S8), thereby ending creation and setting of the collision detection region A of the auxiliary mechanism 9.

After completion of the setting of the collision detection region A, the collision detection unit 15 checks whether or not the tool 2 and the collision detection region A collide with each other.

Thus, according to the present embodiment, the collision detection region A of the auxiliary mechanism 9 is created by a simple operation of giving setting values to the predetermined basic shape data pre-registered in the storage unit 11. Thus, the collision detection regions A of various auxiliary mechanisms 9 can be easily set in a short time.

When no setting values are input for the non-essential items, the boundary surfaces corresponding to the un-input items are automatically determined to be the edges of the setting region P, for example, edges of the motion range of the tool 2, and a collision detection region A extended to the edges of the setting region P is automatically set. In other words, the operator can omit inputting setting values for the non-essential items, and thus the collision detection region A can be more easily set in a shorter time. For example, in the example illustrated in FIGS. 2 to 5, inputting setting values for sixteen setting items has been required conventionally. However, according to the present embodiment, the number of setting items that require inputting of the setting values can be reduced to nine.

In addition, by extending the collision detection region A to the edges of the motion range of the tool 2, collision between the tool 2 and the auxiliary mechanism 9 can be more reliably prevented, and safety can be enhanced.

Furthermore, when the operator has forgotten to input setting values for the non-essential items, the collision detection region A can be automatically adjusted to enhance the safety.

Furthermore, in the case of the additional two-axes table, the tool 2 does not usually move to the outside of the rotary table 9a in the X direction and Y direction during machining of the workpiece W. Thus, movement of the tool 2 is not restricted beyond what is necessary when the collision detection region A is extended to the edges of the motion range of the tool 2.

When the collision detection region A includes multiple partial regions A2 and A3 that encompass the stationary portions 9b, there are more than one boundary surfaces of the partial regions A2 and A3 on the same side of the collision detection region A. In the present embodiment, the item that determines the position of a boundary surface other than the outermost boundary surface among the multiple boundary surfaces on the same side may be a non-essential item. For example, in the example illustrated in FIGS. 2 to 5, the smaller one of Δm and Δn may be a non-essential item. When one of Δm and Δn is an un-input item, the region setting unit 14 determines said one of Δm and Δn to be the same as the setting value of the other.

As a result, the number of setting items that require inputting of the setting values can be further reduced to eight.

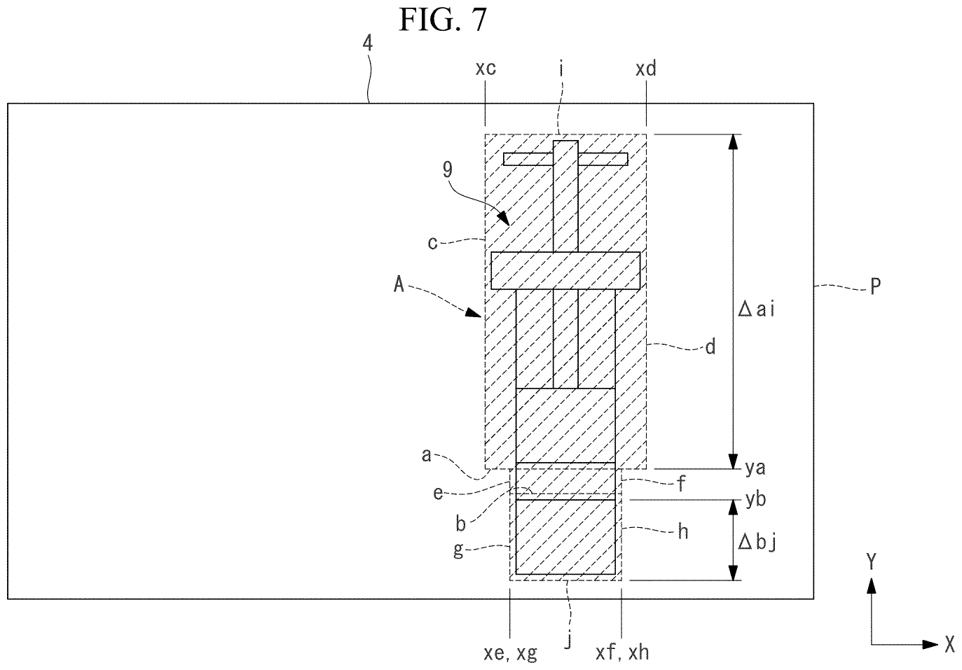

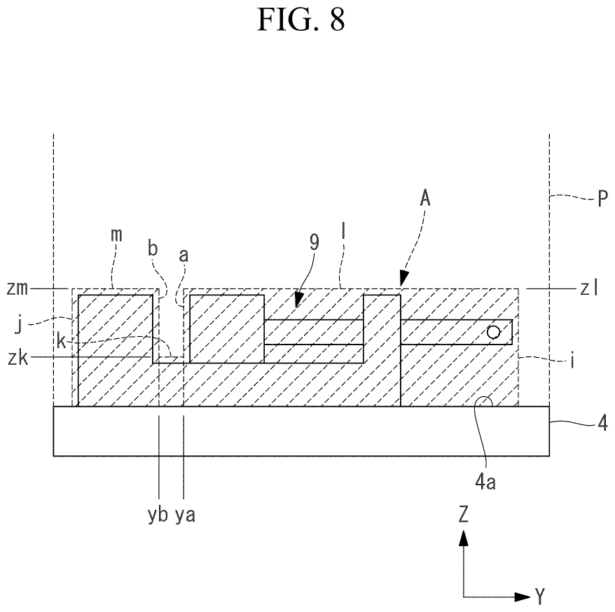

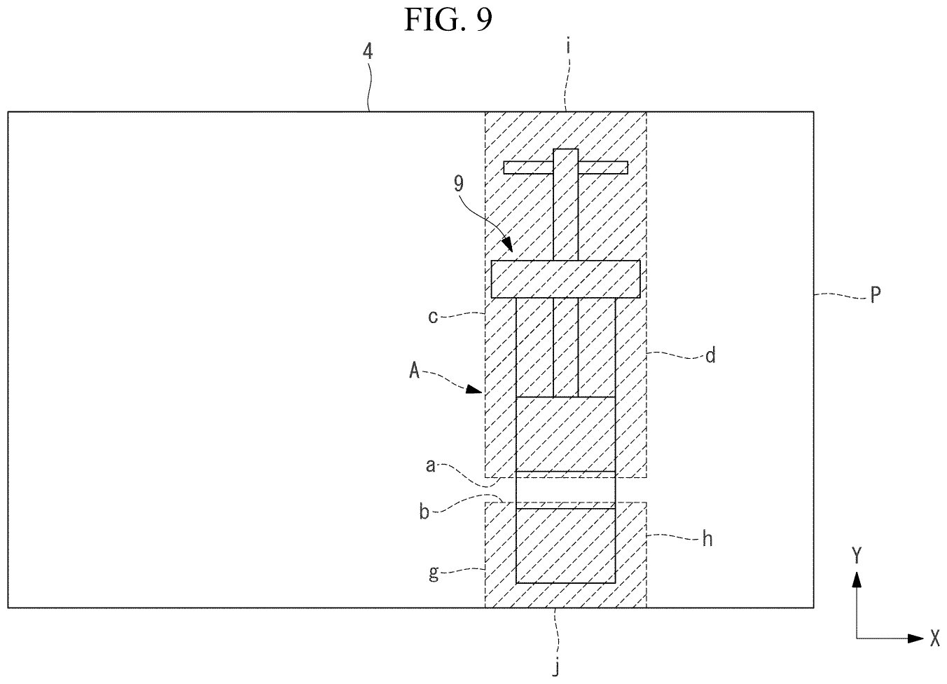

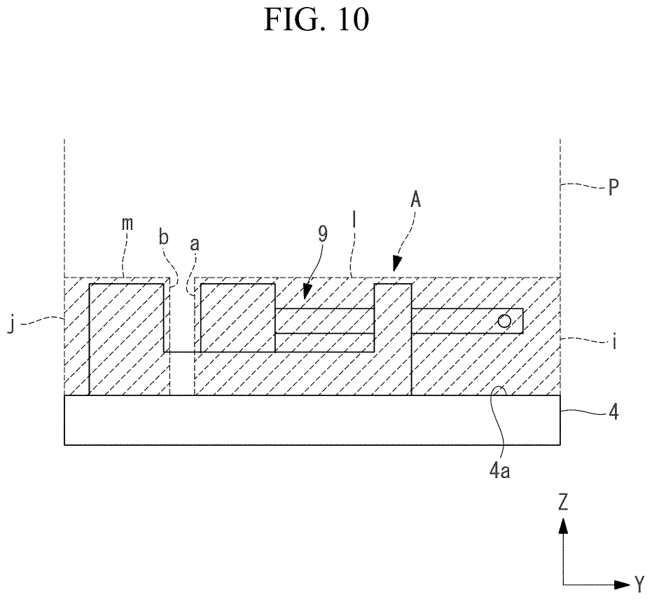

FIGS. 7 to 10 illustrate an example of the collision detection region A when the auxiliary mechanism 9 is a vise, which is a type of fixture. The collision detection region A of the vise consists of three partial regions that respectively encompass three stationary portions. In the example illustrated in FIGS. 7 to 10, thirteen setting items 1 to 13 are provided. FIGS. 7 and 8 illustrate a collision detection region A when setting values are input for all of the setting items. FIGS. 9 and 10 illustrate an extended collision detection region A when setting values are not input for all of the non-essential items.

The setting items 1 and 2 are the Y coordinates ya and yb of the boundary surfaces a and b. The setting items 3 to 8 are the X coordinates xc, xd, xe, xf, xg, and xh of the boundary surfaces c, d, e, f, g, and h. The setting item 9 is the width Δai between the boundary surfaces a and i, and the setting item 10 is the width Δbj between the boundary surfaces b and j. The setting items 11, 12, and 13 are the Z coordinates zk, zl, and zm of the boundary surfaces k, l, and m.

Examples of the non-essential items are items Δai and Δbj for determining the positions of the boundary surfaces i and j facing the outside of the collision detection region A in the Y direction along the mounting surface 4a.

Other examples of the non-essential items are items xe and xg for determining the positions of two boundary surfaces e and g other than the outermost positioned boundary surface c selected from among three boundary surfaces c, e, and g positioned on the same side of the collision detection region A.

Yet other examples of the non-essential items are items xf and xh for determining the positions of two boundary surfaces f and h other than the outermost positioned boundary surface d selected from among three boundary surfaces d, f, and h positioned on the same side of the collision detection region A.

Yet another example of the non-essential items is an item zm for determining the position of the boundary surface m other than the outermost positioned boundary surface 1 selected from two boundary surfaces 1 and m positioned on the same side of the collision detection region A.

In this example, there are five essential items and seven non-essential items. In other words, the number of setting items that require inputting of the setting values by the operator can be further reduced to five from the conventional thirteen.

The more complicated the basic shape data used to create the collision detection region A and the larger the number of boundary surfaces, the larger the amount of computation needed to create the collision detection region A and the larger the load imposed on the controller 1. In order to decrease the amount of computation, the collision detection region A does not have to be set in some part of the auxiliary mechanism 9 that collides rarely with the tool 2.

For example, in FIGS. 7 and 8, the middle partial region between the boundary surfaces a and b corresponds to a portion that receives the lower surface of the workpiece W. As illustrated in FIGS. 9 and 10, the operator may omit this middle partial region by judging that this portion is highly unlikely to collide with the tool 2. In this case, since there is no item zk, there are eight non-essential items.

In this embodiment, the region setting unit 14 may automatically set the setting values for some of the setting items by referring to the position information of the auxiliary mechanism 9 already stored in the storage unit 11.

There may be cases where the position information regarding the position of the auxiliary mechanism 9 has already been input to and set in the controller 1 before starting the setting of the collision detection region A. For example, in the case of an additional two-axes table, the position and the direction of the tilting axis B are stored in the storage unit 11 before the setting of the collision detection region A. In such a case, the region setting unit 14 automatically sets the setting values for the items (Bx, By, Bz) on the basis of the position and direction of the tilting axis B stored in the storage unit 11. As a result, the number of setting items that require the operator to input setting values can be further reduced.

Extending the collision detection region A enhances the safety. In the present embodiment, the controller 1 may be further equipped with a suggestion unit 16, and, when there is a space in the setting region P where no object is present, the suggestion unit 16 may suggest extension of the collision detection region A so that this space is included in the collision detection region A.

For example, a visual sensor 17, such as a camera, installed above the table 4 captures an image of the setting region P. The suggestion unit 16 determines whether or not there is an object between the auxiliary mechanism 9 and the edges of the setting region P on the basis of the image. When it is determined that there is no object, the suggestion unit 16 suggests, to the operator, changing the boundary surface of the collision detection region A to an edge of the setting region P to extend the collision detection region A.

The suggestion unit 16 determines, from the image, whether or not there is an object in a gap having a predetermined width or less between two partial regions, and when the suggestion unit 16 determines that there is no object, the suggestion unit 16 may suggest to the operator to extend the two partial regions and integrate these regions.

Instead of the suggestion unit 16 suggesting the extension of the collision detection region A, the region setting unit 14 may automatically extend the collision detection region A.

In order to decrease the amount of computation required to set the collision detection region A and to decrease the load imposed on the controller 1, the suggestion unit 16 may suggest, to the operator, a collision detection region A having a simpler shape. For example, after the basic shape data is selected by the operator, the suggestion unit 16 may suggest extending the collision detection region A or combining multiple partial regions into one.

In the present embodiment, examples in which the auxiliary mechanisms 9 are an additional axis table and a fixture are described; alternatively, the auxiliary mechanism 9 may be any desired device installed on the mounting surface 4a. For example, the auxiliary mechanism 9 may be a contact-type tool length measurement switch for measuring the tool length. In addition, multiple auxiliary mechanisms 9 may be installed on the mounting surface 4a, and, in such a case, multiple collision detection regions A may be set.

In the present embodiment, the spindle 3 is movable in the Z direction, and the table 4 is movable in the X direction and the Y direction; however, it suffices that the relative movement between the spindle 3 and the table 4 is achieved by moving one or both of the spindle 3 and the table 4. For example, the spindle 3 may be movable in the X and Y directions, and the table 4 may be movable in the Z direction; alternatively, one of the spindle 3 and the table 4 may be movable in three directions, X, Y, and Z.

Furthermore, in the present embodiment, the spindle 3 is arranged vertically, and the table 4 is arranged horizontally; however, the directions in which the spindle 3 and the table 4 are arranged can be modified as appropriate. For example, the spindle 3 may be arranged horizontally, and the table 4 may be arranged vertically.

1. A machine tool controller that has a function for detecting a collision between a tool and an auxiliary mechanism on a table, the controller comprising:
a storage unit configured to store three-dimensional basic shape data;
a region setting unit that creates a collision detection region of the auxiliary mechanism based on the basic shape data and sets the collision detection region within a predetermined setting region encompassing the auxiliary mechanism; and
an input unit to which an operator inputs a setting value for a plurality of setting items for determining positions of a plurality of boundary surfaces of the collision detection region, wherein
the plurality of setting items includes at least one non-essential item for which input of the setting value is not mandatory,
the region setting unit sets the collision detection region based on the setting value input through the input unit, and,
when there is an un-input item, which is the non-essential item for which no setting value is input, the region setting unit sets at least one of the boundary surfaces to be determined by the un-input item at an edge of the predetermined setting region.

2. The machine tool controller according to claim 1, wherein the predetermined setting region is a motion range of the tool.

3. The machine tool controller according to claim 1, wherein the non-essential item is an item for determining a position of a boundary surface that encompasses a stationary portion of the auxiliary mechanism among the boundary surfaces facing outside of the collision detection region.

4. The machine tool controller according to claim 1, wherein the non-essential item is an item for determining a position of a boundary surface other than an outermost boundary surface among two or more boundary surfaces that are positioned on a same side of the collision detection region.
